(19) United States
(12) Patent Application Publication
(10) Pub. No.: US 2020/0057980 A1
(43) Pub. Date: Feb. 20, 2020

(54) SYSTEM AND METHOD FOR ASSET TRACKING AND MANAGEMENT

(71) Applicants: Aaron Perkowitz, Los Angeles, CA (US); Angot Pierre, Paris (FR)

(72) Inventors: Aaron Perkowitz, Los Angeles, CA (US); Angot Pierre, Paris (FR)

(21) Appl. No.: 16/104,317

(22) Filed: Aug. 17, 2018

(51) Int. Cl. G06Q 10/08; G06K 19/06; H04L 9/06; G06F 9/54

(52) U.S. Cl. CPC G06Q 10/087; G06F 9/54; H04L 9/0637; G06K 19/06037

(57) ABSTRACT

A system and method for asset tracking and management is disclosed. The system includes servers for implementing a blockchain that tracks ownership and usage of assets, wherein each transaction in the blockchain includes an asset identifier that identifies a particular asset and a custodian identifier that identifies a particular custodian of a particular asset. The servers create a new transaction in the blockchain for a newly created asset and to include an asset identifier for the newly created asset together with a custodian identifier to whom the newly created asset is assigned. The system includes electronic devices in communication with the servers to provide updates to the blockchain as to ownership and usage of assets, and generate an integrated code comprising a combination of barcode and QR code when a particular asset is created. The electronic devices add a new transaction to the blockchain using the generated barcode and QR code, to specify a new custodian identifier when a particular asset is assigned and to specify when an update or change is made to a particular asset.

### TECHNICAL FIELD

The present disclosure relates to tracking and management of assets.

### BACKGROUND

With the rapid growth of industrialization, it is difficult to prevent the illegal transfer of assets to the grey and black markets. Although, supply chain management solutions are present in the market, however these solutions are not effective, thereby failing to prevent the illegal transfers.

For example, companies use both QR codes and barcodes on packages for inventory control, price tracking and the like. However, with both the QR codes and barcodes present on the packages, it is a daunting task to scan the packages wherein each is scanned in a different way. Some packages have a simple barcode, some of the packages have both a QR code and a barcode, and some of the packages have multiples of both. Treating every package differently due to different combinations of QR codes and barcodes, and due to multiple codes being present, is highly inefficient.

Further, for instance, the QR code hold both unique and generic data, wherein the QR code redirects a user to a website from where data is downloaded for the package. However, should the download be slow, or the network connectivity is not proper, then companies would be crippled as they cannot scan the next package without downloading information from the first.

Furthermore, for instance, some of the companies' use outdated infrastructure due to which they are not able to scan QR codes. In such scenarios, either the companies loose on the data stored in the QR codes or they have to upgrade their infrastructure for additional scanning of QR codes apart from the barcodes, which is not cost effective.

Conventionally, users are not able to track details of the packages to validate the authenticity of the packages. The assigning of the assets, such as the packages from one custodian of the package to another custodian of the package is not updated dynamically and the information about the assignment of the asset or each of the custodian of the asset cannot be extracted from the QR codes and/or barcodes.

Therefore, there is a need to alleviate drawbacks associated with the prior arts.

### SUMMARY

According to one aspect of the present invention, there is provided a system for asset tracking and management. The system includes one or more servers for implementing a blockchain that tracks ownership and usage of assets, wherein each transaction in the blockchain includes an asset identifier that identifies a particular asset and a custodian identifier that identifies a particular custodian of a particular asset. The one or more server further creates a new transaction in the blockchain for a newly created asset and to include an asset identifier for the newly created asset together with a custodian identifier to whom the newly created asset is assigned. The system includes one or more electronic devices in communication with the one or more servers to provide updates to the blockchain as to ownership and usage of assets. The one or more devices generate a combination of barcode and QR code when a particular asset is created and add a new transaction to the blockchain using the generated barcode and QR code, to specify a new custodian identifier when a particular asset is assigned and to specify when an update or change is made to a particular asset.

According to another aspect of the invention, there is provided a method for asset tracking and management. The method includes running a blockchain on one or more servers to track ownership and usage of assets, wherein each transaction in the blockchain includes an asset identifier that identifies a particular asset and a custodian identifier that identifies a particular custodian of a particular asset. The method further includes creating a new transaction in the blockchain for a newly created asset and to include an asset identifier for the newly created asset together with a custodian identifier to whom the newly created asset is assigned. Further, the method includes generating a new transaction in the blockchain for a newly created device or instance of software and including an asset identifier for the newly created device or instance of software together with a custodian identifier to whom the newly created device or instance of software is sold, and includes receiving from a blockchain client application running on one or more electronic devices that communicates with the one or more servers, updates as to ownership and usage of assets. The method further includes generating, by the one or more electronic devices, a combination of barcode and QR code when a particular asset is created; and adding a new transaction to the blockchain to specify a new custodian identifier when a particular asset is sold and to specify when an update or change is made to a particular asset. In one embodiment, the one or more electronic devices are used by one or more users or one or more custodians to scan the combination of barcode and QR code associated with the assets. The scanned information obtained from the combination of barcode and QR code is used to track the assets by the one or more custodians and/or by the one or more users.

### BRIEF DESCRIPTION OF THE DRAWINGS

FIG. 1 is a block diagram of a system for assets tracking and management using a blockchain, according to an example embodiment.

FIG. 2 is a diagram illustrating an operational flow of the system depicted in FIG. 1, according to an example embodiment.

FIG. 3 is a diagram illustrating an integrated QR code and barcode, according to an example embodiment.

FIG. 4 is a diagram illustrating operational flow of the system depicted in FIG. 1, according to another example embodiment.

FIG. 5 is a block diagram of a server configured to participate in the asset tracking system and method, according to another example embodiment.

FIG. 6 is a block diagram of an electronic device configured to participate in the asset tracking system and method, according to another example embodiment.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections; the actual physical connections may be different.

Presented herein is a system and method that uses blockchain technology as a data tracking tool covering chain of ownership and change/update information. In one non-limiting embodiment, an asset may be a piece of hardware (a physical device or thing) or (an instance of) software.

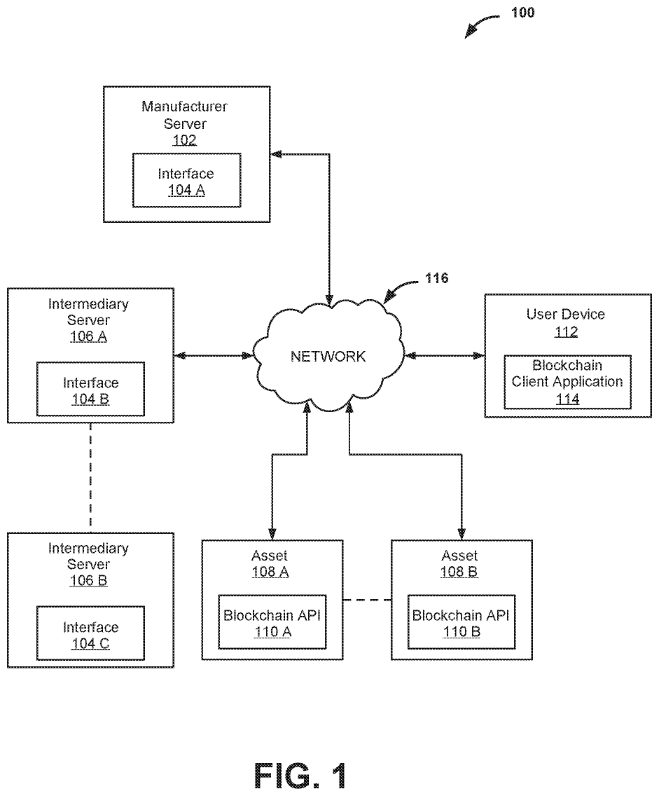

Referring to FIG. 1, a system 100 is shown. The system 100 includes a manufacturer server 102, one or more intermediary servers 106(a)-106(b), one or more electronic devices (hereinafter referred as user device 112 as shown in FIG. 1 for the purpose of description), and a plurality of assets 108(a)-108(b). While only a single manufacturer server 102 is shown, this is by way of example, and it should be understood that there may be a plurality of manufacturer servers. Communication among these elements is by way of network 116. Network 116 may be any combination of private and public local area networks and wide area networks (both wired and wireless), including the public Internet. The manufacturer server 102 and intermediary servers 106(a)-106(b) comprise an interface which runs instances of a blockchain server application for a blockchain.

The instances of the blockchain server application enable different entities to have access and control to a blockchain that stores data which tracks information about assets 108(a)-108(b), ultimately to provide visibility into that information when that information is requested by an entity. Thus, the instances of the blockchain server application running on the interfaces 104(a)-104(b) provide access to the blockchain above.

The user device 112 run a blockchain client application 114. The blockchain client application 114 allows a customer to upload information about an asset to the blockchain, but without permissions to view other nodes/blocks in the blockchain or to alter the blockchain in any way. In an embodiment, the blockchain client application 114 may allow the user device 112 to download information about an asset from the blockchain.

In one non-limiting embodiment, the assets 108(a)-108(b) may be any physical device or thing. In another non-limiting embodiment, the assets 108(a)-108(b) may have sufficient computing and connectivity capabilities that they may run the blockchain client API 110(a)-110(b), but not always. Thus, while FIG. 1 shows that assets 108(a)-108(b) include computing capabilities to run the blockchain client API, this is not meant to be limiting as there may be numerous devices that do not have such capabilities. In further non-limiting embodiment, the assets 108(a)-108(b) may be entirely one or more software program instances.

A blockchain is a public ledger mechanism, and as used herein, it lists the owners of each asset. A blockchain is also a distributed system, using cryptographic methods to ensure that each transfer of assets is valid. According to the techniques presented herein, the blockchain is used to ensure that each asset (a manufacturer's product, for example) is being used only by its registered custodian. The blockchain also tracks certain usage and change information about the asset.

The blockchain configuration used in accordance with the methods presented herein facilitates trust among a manufacturer's channel partners, resellers, and customers because there is a single public, fault tolerant, tamper resistant source of truth which allows for verification that each transaction is legal, and each asset is an authentic product. It also gives a manufacturer's services and other authorized service providers insight into the entire chain of custody for a particular asset, as well insight into the asset's specific usage information.

In one non-limiting embodiment, a blockchain transaction involves two components: (1) a unique way of identifying the custodian, and (2) a unique way of identifying the asset. Various identification methods are presented herein, and all create a unique asset identifier (ID) used to specifically refer to a single asset.

In one non-limiting embodiment, the blockchain may comprise of multiple layers of permissions, both created and maintained by the manufacturer, for example. The manufacturer may also share and delegate this authority to trusted partners/custodians. Although it is not shown in FIG. 1, the permission lists are actually stored in the blockchain, and only the manufacturer, in this example, can change or add to the permission lists.

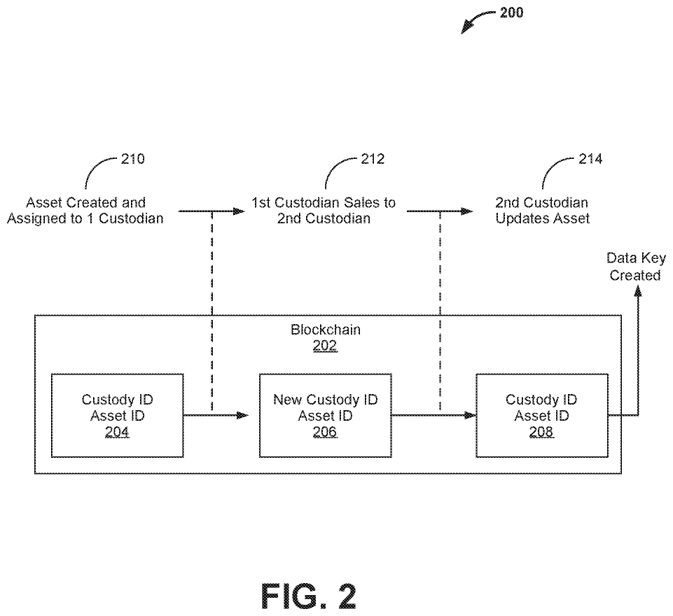

Reference is now made to FIG. 2. FIG. 2 is a pictorial representation of the blockchain and related process 200. The blockchain is shown at reference numeral 202. At 210, the manufacturer or authorized contract manufacturer (CM) creates an asset. Typically, the manufacturer server 102 comprises the interface 104(a) which run an instance of a blockchain application. Using the instance of the blockchain application, it creates a transaction 204 that includes an Asset ID and a custodian ID of the custodian of the asset to which the manufacturer has sold or assigned the asset. In an embodiment, the transaction 204 may include only an Asset ID without knowing the custodian of the asset. In cases, where the next custodian is not known to the manufacturer server 102, the custodian ID of the manufacturer itself may be used along with the Asset ID. Next, the custodian of the asset sells or assigns the asset at 212, and a new transaction 206 in the blockchain is created that includes the New custodian ID and the Asset ID. In an exemplary embodiment, the one or more intermediary servers 106(a)-106(b) along with the user device (112) may be utilized by the custodians to implement the above described operations.

In one non-limiting embodiment, at a regular (periodic or non-periodic) interval, the asset will retransfer itself to its current custodian by creating a new transaction. The transaction will be signed by the current custodian's private key for both the previous and new custodians and will include a new updated data block. If the transaction fails, the assets will no longer function, or will revert to non-functional mode as appropriate until a successful ownership transaction can be made.

In one non-limiting embodiment, transferring of an asset tracked with the blockchain 202 as described in the present invention is secure and easy because of two reasons. First, the Asset ID, which is unique to the asset. Second, the transaction is signed by the previous custodian using their private key, and then also signed by the new custodian using their private key. In one embodiment, both private keys are issued by the manufacturer or a delegated partner, to insure the user has permission to receive and use the asset. In another embodiment, at the time of transfer, certain data about the new custodian may be stored in the data block of the blockchain transaction. This may include things like geo-location, current software stack version, and usage statistics.

In an event, a user wants to see the history of a particular asset, the blockchain allows the user to look up the chain of ownership in the blockchain by preforming a search on that Asset ID. In addition, only the manufacturer and its delegated partners may perform search on the blockchain using private keys, unless the manufacturer decides not to allow that in some situations. This creates a major competitive advantage for manufacturer to maintain the authenticity of the asset, as the unauthorized intruders who will not have access to this data.

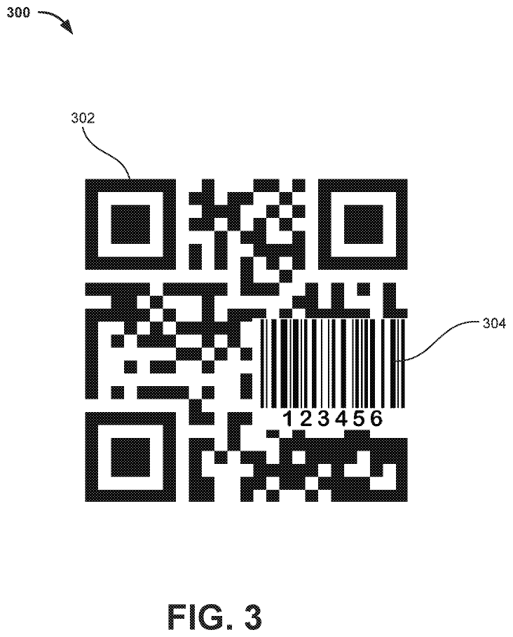

FIG. 3 shows an integrated QR code and barcode which may be generated by manufacturer using one or more electronic devices (for example the electronic device 112). The one or more electronic devices may connect to an interface 104(a) of the manufacturer server 102, which runs a blockchain application. At the time of creating the asset, the blockchain transaction is created as described above in the description. The integrated code includes a QR code 302 and a barcode 304. In one embodiment, a barcode is an optical, machine-readable, representation of data; the data usually describes something about the object that carries the barcode. The barcodes systematically represent data by varying the widths and spacings of parallel lines and may be referred to as linear or one-dimensional (1D). In one embodiment, QR code refers to a quick response (QR) Code which is a two-dimensional barcode (e.g., information provided in two dimensions). The QR Code contains information in both vertical and horizontal directions, and therefore, a QR Code can hold a greater volume of information than a bar code, and are often used to contain web address, a message, contact information, and more. In one embodiment, as the integrated code is scanned by a scanner, the asset id and a custodian id are updated on the blockchain. In instances, where the network connectivity is not available at the local system or scanner, and/or the blockchain is congested, the scanned information from the integrated code is stored locally and pushed again until it is successfully uploaded to the blockchain. In one non-limiting embodiment, to fight counterfeits, only the manufacturer needs to have the integrated code comprising a QR code and a barcode.

In one non-limiting embodiment, the integrated code having a QR code and a barcode, may be printed directly onto an item's packaging or the item itself instead of a sticker which is then attached. This helps to reduce copies of the UPC/barcode as users who scan the code will note that it is abnormal that the code is a sticker rather than embedded into the product. In another non-limiting embodiment, the integrated code may have a holographic background so that copies are even harder to produce.

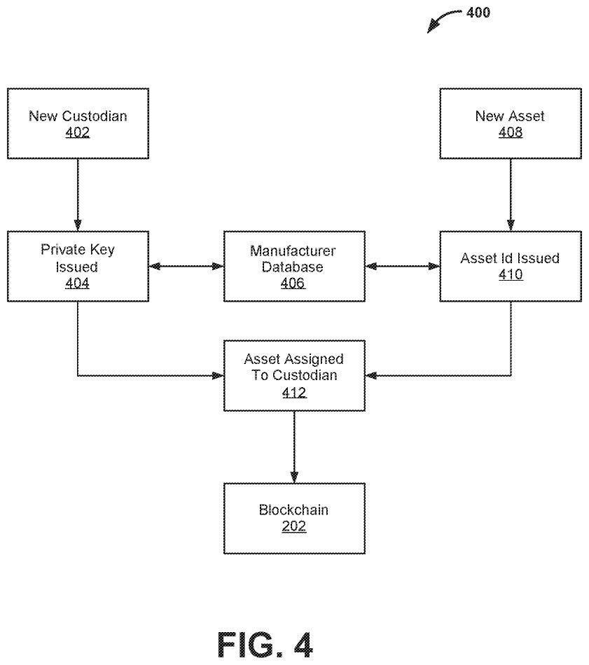

FIG. 4 illustrates another view of the operational flow. In this figure, an internal database 406(maintained by the manufacturer, for example) is shown that is used to store various keys used by entities to update blocks in the blockchain 202. On top left of FIG. 4, operations 402 and 404 are performed when a new customer is to be sold an asset. In one embodiment, at 404, a private key (also referred to herein as the blinding key) is issued to the new customer, and this private key is stored in the database 406. On the top right of FIG. 4, a flow is shown when a new asset is to be added to the blockchain. At 408, a new asset is created or allocated, and an Asset ID is issued for the asset (using any of the techniques described above) at 410. At 412, the asset is sold or assigned to a customer/custodian and a transaction is added for the blockchain 202 for this event.

Existing technologies for barcodes exist among different sized barcodes that can hold different amounts of data. However, these barcodes are not readable by consumers/custodians and typical UPCs are still needed for inventory input. There are larger barcodes that can hold more data, yet most consumers/custodians lack the infrastructure to read them and traditional legacy systems cannot input this long string of data into their systems. Therefore, existing technology revolves around adding additional items to the box such as more QR codes. However, in the present invention, cost, accessibility and integration into current systems are large advantages. The technology of the present invention easily integrates with existing systems as most logistics companies have a QR scanner, they simply need the correct application module running in the background. By correct application module running in the background, the integrated code comprising a barcode and QR code is scanned which enables extracting of data from both the codes simultaneously, thereby allowing easy integration with legacy systems. The blockchain client application as described in the present invention will make no noticeable difference to their everyday business and in one embodiment, the blockchain client application will not be active until it sees one of the integrated codes having a QR code and a barcode

The system and methods described above in connection with FIGS. 1-4 is designed to track ownership and use of assets. This is useful to gain visibility into a product's lifecycle. Product usage includes who owned the product, where, when, and any major changes made to the product. In one embodiment, the systems and methods presented herein may be used to track history and the identities of people/organizations that were involved in “touching” the product or making changes, enhancements/upgrades, replacements of parts, etc., regardless of transfer of ownership of the product. This system and method do not attempt to prevent black market activity, but instead simply tracks it, and makes information available later to any entity that is interested in that information, such as vigilance community of a manufacturer.

In one non-limiting embodiment, the blockchain used herein is configured to limit who can view the private data and who has access/ownership to the data blocks in the blockchain. In order to preserve security and prevent someone from taking over the blockchain, restrictions are made as to who can be a blockchain node by running the blockchain software. This is limited to a particular group: the manufacturer and its “trusted partners” (referred herein a custodians).

In one non-limiting embodiment, the blockchain system also supports legal partners and resellers of a manufacturer's technology, in a way that prevents illegal copying. For example, if a verified owner wants to sell their asset, they can create a transaction in the blockchain which identifies them as the current owner. Using the blockchain, they can effectively transfer ownership, deactivating any instances from the old owner, and allowing the new owner to immediately activate their asset.

Upon manufacturing, each hardware device would be assigned an initial asset ID. Subsequently, as part of product supply chain, once the device is purchased by/to be shipped to the customer, an entry is created in the manufacturer blockchain which ties that customer ID to the asset ID. Additional information such as the purchase details (like product ID, authorization/customer ID, partner ID, other partner parameters, potential install base location etc.) may be added in the data portion of the blockchain transaction on a per-device basis, and which details are relevant only to a provider, for example. The transaction ID and asset ID will be embedded within the integrated code comprising a QR code and a barcode, and further the product is shipped to customer.

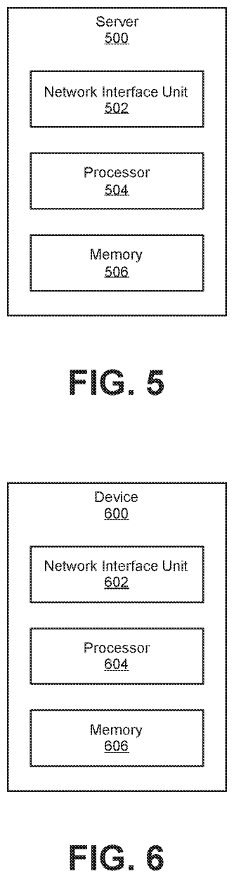

FIG. 5 shows a block diagram of a blockchain server 500 according to an example embodiment. This diagram is meant to represent any of the servers 102 and 106(a)-106(b) in FIG. 1. A blockchain server 500 includes one or more processors (e.g., microprocessors or microcontrollers) 504, one or more network interface units (e.g., network interface cards, switches, etc.) 502 to enable network communications, and memory 506 that stores blockchain server software. The blockchain server software enables the interface 104(a) of the blockchain server 500 to perform the server side blockchain operations described herein.

FIG. 6 illustrates a simple block diagram of a device 600 that may be part of the trust solution presented herein. The block diagram of FIG. 6 is meant to be generically representative of any of the assets 108(a)-108(b) shown in FIG. 1 and user device 112 shown in FIG. 1. The device 600 includes one or more processors (e.g., microprocessors or microcontrollers) 604, one or more network interface units 602 to enable wired or wireless network communications, and memory 606 that stores blockchain client API software and, in some forms, a blockchain client application. It is to be understood that the device 600 may further include various other components, such as network processing hardware (application specific integrated circuits) in the case of a network device, or any other combination of hardware or software components that are used in a particular type of device that is to be tracked according to the techniques presented herein.

The memory 506 and 606 shown in FIGS. 5 and 6 may include read only memory (ROM), random access memory (RAM), magnetic disk storage media devices, optical storage media devices, flash memory devices, electrical, optical, or other physical/tangible memory storage devices. Thus, in general, the memory may comprise one or more tangible (non-transitory) computer readable storage media (e.g., a memory device) encoded with software comprising computer executable instructions and when the software is executed it is operable to perform the operations described herein.

The flowchart and schematic diagrams illustrate the architecture, functionality, and operations of some embodiments of methods, systems, and computer program products for managing security associations over a communication network. In this regard, each block may represent a module, segment, or portion of code, which comprises one or more executable instructions for implementing the specified logical function(s). It should also be noted that in other implementations, the function(s) noted in the blocks may occur out of the order noted in the figures. For example, two blocks shown in succession may, in fact, be executed substantially concurrently or the blocks may sometimes be executed in the reverse order, depending on the functionality involved.

In the drawings and specification, there have been disclosed exemplary embodiments of the invention. Although specific terms are employed, they are used in a generic and descriptive sense only and not for purposes of limitation.

1. A system for asset tracking and management, the system comprising:
one or more servers configured to implement a blockchain that tracks ownership and usage of assets, wherein each transaction in the blockchain includes an asset identifier that identifies a particular asset and a custodian identifier that identifies a particular custodian of a particular asset,
wherein the one or more servers are configured to create a new transaction in the blockchain for a newly created asset and to include an asset identifier for the newly created asset together with a custodian identifier to whom the newly created asset is assigned; and
one or more electronic devices in communication with the one or more servers to provide updates to the blockchain as to ownership and usage of assets,
wherein the one or more electronic devices are configured to generate an integrated code comprising a combination of barcode and QR code when a particular asset is created, and
wherein the one or more electronic devices are configured to add a new transaction to the blockchain using the generated barcode and QR code, to specify a new custodian identifier when a particular asset is assigned and to specify when an update or change is made to a particular asset.

2. The system of claim 1, wherein the one or more electronic devices comprising a blockchain client application that enables communication with the blockchain module running on the one or more servers so as to add a new transaction in the blockchain when an update or change is made to the asset.

3. The system of claim 2, wherein the blockchain client application is configured to regularly create a new transaction on the blockchain, the new transaction indicating an asset identifier and custodian identifier for the associated asset, and wherein the one or more servers having an interface are configured to evaluate the new transaction to determine whether the asset is still being used by a registered custodian.

4. The system of claim 2, wherein the one or more servers are configured to send a validation response to the blockchain client application indicating whether or not the associated user device is permitted to continue normal operation based on whether the asset is being used by a registered custodian.

5. The system of claim 2, wherein the blockchain client application on the one or more electronic device is configured to recognize the combination of QR code and barcode present on the asset, by interacting with a blockchain API present on the assets.

6. A method for asset tracking and management, the method comprising:
running a blockchain on one or more servers configured to track ownership and usage of assets, wherein each transaction in the blockchain includes an asset identifier that identifies a particular asset and a custodian identifier that identifies a particular custodian of a particular asset,
creating a new transaction in the blockchain for a newly created asset and to include an asset identifier for the newly created asset together with a custodian identifier to whom the newly created asset is assigned; and
generating a new transaction in the blockchain for a newly created device or instance of software and including an asset identifier for the newly created device or instance of software together with a custodian identifier to whom the newly created device or instance of software is sold;
receiving from a blockchain client application running on one or more electronic devices that communicates with the one or more servers, updates as to ownership and usage of assets;
generating, by the one or more electronic devices, an integrated code comprising a combination of barcode and QR code when a particular asset is created; and
adding a new transaction to the blockchain to specify a new custodian identifier when a particular asset is sold and to specify when an update or change is made to a particular asset.

7. The method of claim 6, comprising:
enabling, by a blockchain client application, communication with the blockchain module running on the one or more servers so as to add a new transaction in the blockchain when an update or change is made to the asset.

8. The method of claim 7, wherein running a blockchain includes:
regularly creating a new transaction on the blockchain, the new transaction indicating an asset identifier and custodian identifier for the associated asset, and
evaluating, by the blockchain module residing on an interface of the one or more servers, the new transaction to determine whether the asset is still being used by a registered custodian.

9. The method of claim 8, further comprising:
recognizing, by the blockchain client application on the one or more electronic devices, the combination of QR code and barcode present on the asset, by interacting with a blockchain API present on the assets.

10. The method of claim 9, comprising:
sending a validation response to the blockchain client application indicating whether or not the associated user device is permitted to continue normal operation based on whether the asset is being used by a registered custodian

11. A computer program product for asset tracking and management, the computer program product comprising non-transitory computer-readable media encoded with instructions for execution by a processor to perform a method comprising:
running a blockchain on one or more servers configured to track ownership and usage of assets, wherein each transaction in the blockchain includes an asset identifier that identifies a particular asset and a custodian identifier that identifies a particular custodian of a particular asset,
creating a new transaction in the blockchain for a newly created asset and to include an asset identifier for the newly created asset together with a custodian identifier to whom the newly created asset is assigned; and
generating a new transaction in the blockchain for a newly created device or instance of software and including an asset identifier for the newly created device or instance of software together with a custodian identifier to whom the newly created device or instance of software is sold;
receiving from a blockchain client application running on one or more electronic devices that communicates with the one or more servers, updates as to ownership and usage of assets;
generating, by the one or more electronic devices, a combination of barcode and QR code when a particular asset is created; and
adding a new transaction to the blockchain to specify a new custodian identifier when a particular asset is sold and to specify when an update or change is made to a particular asset.

12. The computer program product of claim 11, further comprising instructions for:
enabling, by a blockchain client application, communication with the blockchain module running on the one or more servers so as to add a new transaction in the blockchain when an update or change is made to the asset.

13. The computer program product of claim 12, further comprising instructions for:
regularly creating a new transaction on the blockchain, the new transaction indicating an asset identifier and custodian identifier for the associated asset, and
evaluating, by the blockchain module residing on an interface of the one or more servers, the new transaction to determine whether the asset is still being used by a registered custodian.

14. The computer program product of claim 13, further comprising instructions for recognizing, by the blockchain client application on the one or more electronic devices, the combination of QR code and barcode present on the asset, by interacting with a blockchain API present on the assets.

15. The computer program product of claim 14, further comprising instructions for sending a validation response to the blockchain client application indicating whether or not the associated user device is permitted to continue normal operation based on whether the asset is being used by a registered custodian.
